(19) United States
(12) Patent Application Publication
(10) Pub. No.: US 2022/0180727 A1
(43) Pub. Date: Jun. 9, 2022

(54) REMOTE CONTROL LOCATOR

(71) Applicant: Liam Murphy, Downers Grove, IL (US)

(72) Inventor: Liam Murphy, Downers Grove, IL (US)

(21) Appl. No.: 17/541,248

(22) Filed: Dec. 3, 2021

Related U.S. Application Data
(60) Provisional application No. 63/120,781, filed on Dec. 3, 2020.

(51) Int. Cl. G08B 21/24; G08B 3/10

(52) U.S. Cl. CPC G08B 21/24; G08B 3/10

(57) ABSTRACT

The present disclosure provides systems and methods for locating a lost remote control or similar device.

### PRIORITY CLAIM

This application claims priority to U.S. Provisional Patent Application Ser. No. 63/120,781, filed Dec. 3, 2020, the entire contents of which are incorporated herein by reference and relied upon.

### FIELD OF THE INVENTION

The present disclosure provides systems and methods for locating a lost remote control or similar device.

### BACKGROUND

Control devices, such as remote control devices, seem to be misplaced frequently, rendering the things they control (televisions, radios, cable receiver boxes, etc.) essentially useless until the control device is located. Efficient methods to locate lost control devices are antiquated (“Did you look under the couch?”) and often add to the frustration. Effective technologies for assisting hearing-impaired and visually-impaired consumers are essentially non-existent. A need for efficient methods to locate lost control devices remains, especially for users with physical impairments. The technologies disclosed herein meet that need.

### SUMMARY

The present disclosure provides systems and methods for locating a lost remote control or similar device. While this disclosure often refers to the lost control device as a “remote control,” one of ordinary skill in the art will recognize that the technologies disclosed herein may easily be adapted for use in other contexts. The term “remote control” should therefore not be construed as limiting the scope of the claims.

In one embodiment, the present disclosure provides a system for locating a lost remote control, the system comprising: a transmitter (110) configured to emit a first lost device signal (130); and a first remote control (200) in electronic communication with the transmitter (110) and configured to emit an audible, visual, and/or tactile signal (210) in response to the first lost device signal (130).

These and other embodiments are described in greater detail below with reference to the accompanying drawings.

### BRIEF DESCRIPTION OF THE FIGURES

FIG. 1 shows a schematic representative view of a system consistent with one embodiment of the present disclosure.

FIG. 2 shows a schematic representative view of a system consistent with another embodiment of the present disclosure.

While specific embodiments are illustrated in the figures, with the understanding that the disclosure is intended to be illustrative, these embodiments are not intended to limit the invention described and illustrated herein. While specific embodiments are illustrated in the figures, with the understanding that the disclosure is intended to be illustrative, these embodiments are not intended to limit the invention described and illustrated herein.

### DETAILED DESCRIPTION

Generally, the present disclosure provides systems and methods for locating a lost remote control or similar device.

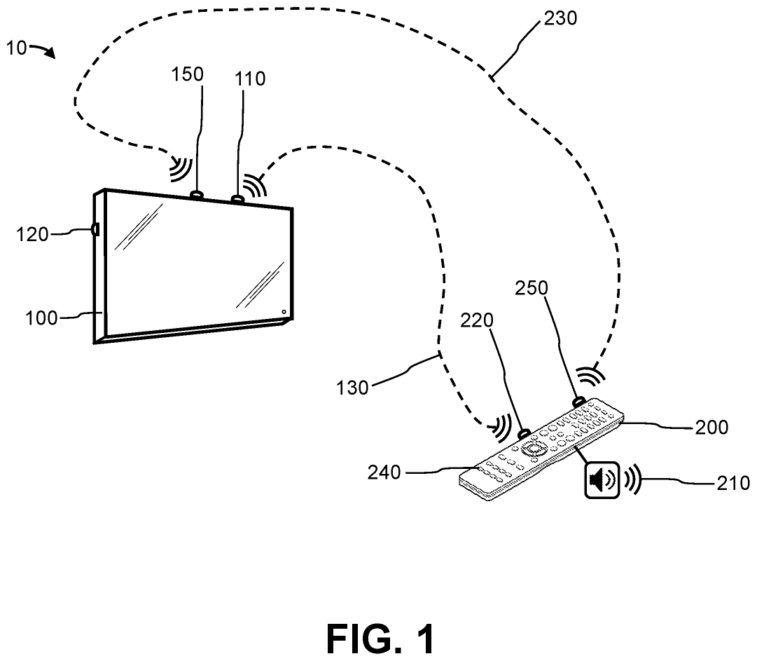

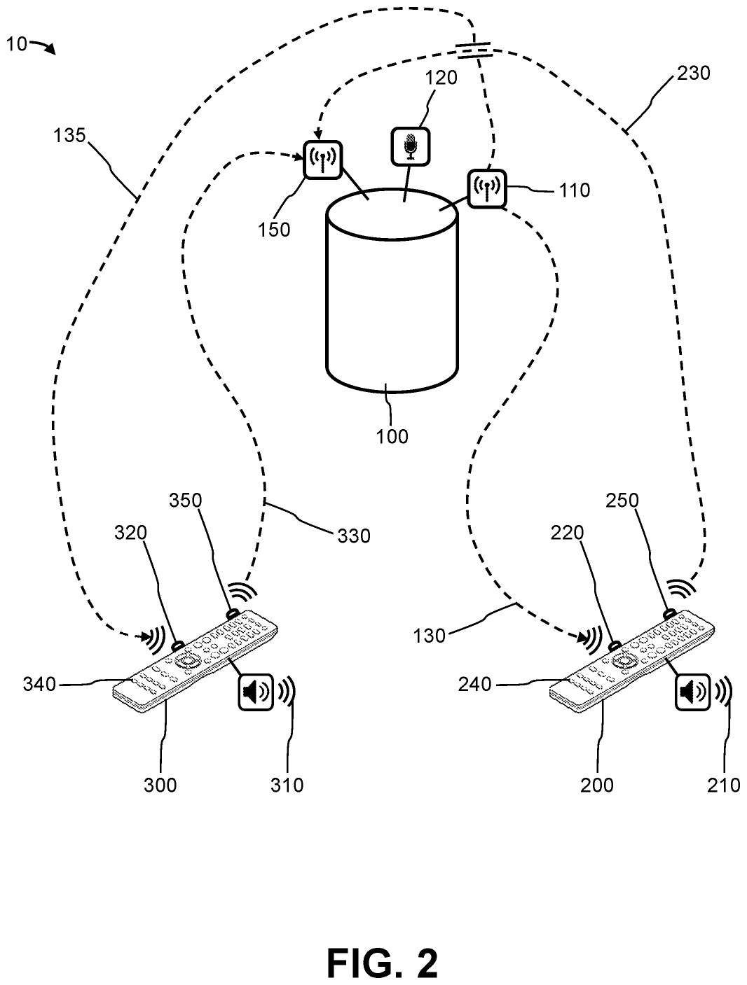

Referring generally to FIGS. 1-2, systems of the present disclosure comprise a transmitter 110 configured to emit a lost device signal 130, and a remote control device 200 in electronic communication with the transmitter 110 and configured to emit a signal 210 (e.g., an audible signal and/or a visual signal) in response to the lost device signal 130.

The transmitter 110 is configured to emit a lost device signal 130, for example using one or more wireless protocols such as Bluetooth (e.g., 2.4 GHz short-range wireless signal), BLE (e.g., low-powered Bluetooth short-range wireless signal), ZigBee (e.g., 2.4 GHz mesh local area network signal), Z-Wave (e.g., sub-GHz mesh network signal), 6LoWPAN (e.g., lightweight IP-based signal), Thread (e.g., IPv6 and/or 6LoWPAN signal(s)), WiFi-ah (also referred to as HaLow, e.g., IEEE 802.11ah signal), 2G TDMA cellular signal, 3G cellular signal, 4G cellular signal, 5G cellular signal, LTE Cat 0 cellular signal, LTE Cat 1 cellular signal, LTE Cat 3 cellular signal, LTE-M1 cellular signal, Narrowband IoT cellular signal (also referred to as NB-IoT), Near field communication wireless signal (also referred to as NFC), active radio frequency identification (RFID) signal, SigFox IoT signal, LoRaWAN media access control signal, Ingenu random phase multiple access/DMSS signal, Weightless-N ultra-narrowband signal, Weightless-P ultra-narrowband signal, Weightless-W TV white space (TVWS) signal, ANT radio signal, ANT+ radio signal, DigiMesh signal, MiWi short-range network signal, EnOcean extremely low power wireless signal, Dash7 wireless network signal, WirelessHART wireless signal, and/or one or more IEEE 802.11 wireless signals (e.g., 802.11-1997, 802.11a, 802.11b, 802.11g, 802.112007, 802.11n, 802.11-2012, 802.11ac, 802.11ad, 802.11af, 802.11-2016, 802.11ai, 802.11aj, 802.11aq, 802.11ax, 802.11ay, 802.11ba, and/or 802.11be).

In some embodiments, the transmitter 110 is configured to emit the lost device signal 130 when a user provides a lost device input to a device 100 associated with the transmitter 130, or alternatively to an input device 120 associated with the transmitter 110 but not incorporated into the device 100 itself (e.g., a stand-alone transmitter-input device 110-120 that operates independently of an associated device 100).

In some embodiments, providing the lost device input comprises contacting an input device 120, such as a button, a touch switch, a touchscreen icon, or similar tangible user interface. In other embodiments, providing the lost device input comprises providing an audible input, such as a spoken word or sound, to the input device 120, which may include a microphone, vibration sensor, or other similar sensor configured to detect an audible input.

In some embodiments, the input device 120 is an IoT device. In some such embodiments, the IoT device may be a smart speaker with voice recognition capabilities, such as an Amazon Echo, a Google Nest, a Sonos One, an Apple HomePod, a JBL Link, or similar. In some embodiments, the IoT device is a television comprising a virtual assistant or speech recognition.

In some embodiments, the input device 120 is a feature (e.g., button) of a cable TV modem.

In some embodiments, the input device 120 is a feature (e.g., a physical button, an on-screen button, or a microphone configured to receive an audible input) of a mobile device such as a cell phone or tablet computer.

In some embodiments, the input device 120 is a feature (e.g., a physical button, an on-screen button, or a microphone configured to receive an audible input) of a laptop computer.

In some embodiments, the input device 120 is a feature (e.g., a physical button, an on-screen button, or a microphone configured to receive an audible input) of a desktop computer.

In some embodiments, the device 100 is a television, and the input device 120 is a feature (e.g., a physical button, an on-screen button, or a microphone configured to receive an audible input) of the television.

In embodiments wherein the input device 120 is associated with a microphone or other audible signal receiver (e.g., a smart speaker, television, or other device with voice recognition capabilities), the lost device input signal may be an audible input such as a spoken word or sound. For example and without limitation, the input device 120 may be a microphone associated with an IoT device 100 such as an Amazon Alexa smart speaker configured to transmit the lost device signal 130 upon recognition of a spoken phrase requesting for help locating the television remote (e.g., “Alexa, I've lost the TV remote again.”).

The lost device 200 in some embodiments includes a lost device signal receiver 220 configured to receive the lost device signal 130 from the transmitter 110. One of skill in the art will recognize that the specific type(s) of lost device signal receiver 220 used in a given application will depend at least on the type/protocol of the lost device signal emitted by the transmitter 110. In some embodiments, the lost device signal receiver 220 is configured to additionally receive signals from transmitters other than the transmitter 110 of the systems 10 disclosed herein.

The lost device 200 is configured to emit a beacon 210, such as an audible signal, a visual signal such as a light or flashing light, a tangible signal such as a vibration, or any combination of any two or more of the foregoing, when the lost device signal 130 is received by the lost device signal receiver 220.

In some embodiments, the beacon 210 is an audible signal such as a chirp, a tone, a pitched note, a word, a phrase, or any two or more of the foregoing. The audible signal in some embodiments is generated by a speaker in operative communication with the lost device signal receiver 220.

In some embodiments, the beacon 210 is a visual signal such as a steady light, a flashing light, or a combination thereof. The visual signal in some embodiments is generated by a visual signal generator, such as an LED light, in operative communication with the lost device signal receiver 220.

In some embodiments, the beacon 210 is a tangible signal such as a vibration, for example generated by an offset-weight motor in operative communication with the lost device signal receiver 220.

In some embodiments, the lost device 200 emits the beacon 210 for a predetermined period of time, for example about 10 seconds, about 20 seconds, about 30 seconds, about 40 seconds, about 50 seconds, about or for about 1 minute. After the predetermined period of time, the lost device 200 stops emitting the beacon 210 until it receives a subsequent lost device signal 130 from the transmitter 110 (e.g., via the lost device signal receiver 220).

In some embodiments, the lost device 200 further includes a found device input 240 that, when activated, causes the lost device 200 to transmit a found device signal 230, for example via a transmitter 250. In some such embodiments, the device 100 may additionally comprise a found device signal receiver 150 configured to receive the found device signal 230 and, optionally, to cause the transmitter 110 to (a) stop transmitting the lost device signal 230, thereby causing the lost device 200 to stop emitting the beacon 210, or (b) transmit a second found device signal (not shown) that, upon receipt by the lost device 200 causes the beacon 210 to stop being emitted. The transmitter 250 may perform additional functions besides transmitting a found device signal 230. For example and without limitation, the transmitter 250 may be an infrared signal generator that additionally communicates with the device 100 to change a TV channel, adjust playback volume, etc.

In some embodiments, the found device input is provided by the user by pressing a button 240 on the lost device 200. In some embodiments, the found device input is provided by the user by making an audible sound, such as speaking a phrase (e.g., “Alexa, I found the remote.”); in such embodiments the found device input 240 comprises a microphone.

In some embodiments, the transmitter 110 is disposed inside the housing of the device 100. In such embodiments, the transmitter 110 may be incorporated into the internal electronics of the device 100. Alternatively, in some embodiments the transmitter 110 is disposed inside the device 100, but is not integrated into the internal electronics that enable the device 100 to perform other functions.

In some embodiments, the lost device signal receiver 220 is disposed inside the housing of the remote control 200. In such embodiments, the lost device signal receiver 220 may be incorporated into the internal electronics that enable the remote control 200 to control other functions of the device 100. Alternatively, in some embodiments the lost device signal receiver 220 disposed inside the remote control 200, but is not electronically integrated into the internal electronics that enable the remote control 200 to control other functions of the device 100.

In some embodiments, the device 100 consists essentially of the transmitter 110, the input device 120, a controller (not shown) in operative communication with the transmitter 110 and the input device 120, and a power source (not shown) such as a button cell battery. In such embodiments, the device 100 may be a stand-alone device not in electronic communication with any other electronic device (other than the desired wireless communications equipment necessary to transmit wireless signals to the lost device 200). For example, one such embodiment may be represented by a simple push button device in a housing with an optional adhesive backing that enables a user to apply the device 100 to a discrete location such as on the back or side of a television, or on a surface of and end table or other furniture. Such relatively simple devices 100 carry an advantage of enabling a user to inexpensively retrofit any equipment that is capable of wirelessly connecting to a remote control or other device that can be potentially misplaced.

Referring now specifically to FIG. 2, systems 10 of the present disclosure may be configured to assist a user in locating one of a plurality of remote control or similar devices 200,300, etc. using a single transmitter 110. As shown representatively in FIG. 2, for example, a device 100 may be a smart speaker equipped with a microphone 120, a transmitter 110, and a receiver 150. The transmitter 110 and receiver 150 may in some embodiments be combined as a transceiver 110/150 (not shown). Upon receiving a lost device input from a user (e.g., “Hey Google, I can't find the Roku remote”) via the microphone 120, the device emits a first lost device signal 130, via the transmitter 110, that includes a unique identifier associated with the first remote control 200 but not associated with any other remote controls (or other wirelessly connected devices) within the system 10. Upon receipt of the first lost device signal 130, the first remote control device 200 (e.g., the Roku remote) emits a first beacon 210. In contrast, while the second remote control device 300 may successfully receive the first lost device signal 130 via its own lost device signal receiver 320, the second remote control device 200 is configured to not emit a beacon 310 because the first lost device signal 130 is not associated with the second remote control device 300. Instead, the second remote control device 300 may be configured to only emit a beacon 310 (which may be different in type and/or duration than the first beacon 210) if the lost device signal 135 is associated with the second remote control device 300.

Any or all of the remote control devices 200,300, etc. may include a transmitter 250,350, etc. configured to emit a found device signal 230,330, etc. that, when received by the device 100 (e.g., via its receiver 150), may cause the device 100 to transmit a signal 130,135, etc. that causes the lost device 200,300, etc. to stop emitting the beacon 210,310, etc.

In some embodiments, the present disclosure provides a system 10 for locating a lost remote control 200, the system comprising: a transmitter 110 configured to emit a first lost device signal 130; and a first remote control 200 in electronic communication with the transmitter 110 and configured to emit an audible signal 210 in response to the first lost device signal 130. In some embodiments, the transmitter 110 is configured to emit the first lost device signal 130 in response to a first lost device user input selection 120. In some embodiments, the transmitter 10 is incorporated into electronics of a television device 100. In some embodiments, the transmitter 10 is incorporated into an IoT device 100. In some embodiments, the IoT device 100 is selected from the group consisting of: a smart speaker (e.g., Amazon Echo, Google Nest, Sonos One, Apple HomePod, JBL Link), a television comprising a virtual assistant, a cable TV modem, a mobile device, a laptop computer, and a desktop computer. In some embodiments, the IoT device 100 is configured to cause the transmitter 110 to emit the first lost device signal 130 in response to a first audible lost device input 120 provided by a user. In some embodiments, the transmitter 110 is incorporated into a stand-alone transmitter device comprising: an activation button 120 in operative communication with the transmitter 110; and a power source (e.g., an AC/DC power supply or a DC power supply such as a battery) in operative communication with the transmitter 110 and the activation button 120, wherein upon activation of the activation button 120, the transmitter device 110 emits the first lost device signal 130. In some embodiments, the device 100 further comprises a receiver 150 in operative communication with the transmitter 110 and configured to receive a first found device signal 230 from the first remote control 200, wherein the first remote control 200 is configured to: receive a first found device user input 240 upon being located by a user; and transmit the first found device signal 230 to the receiver 150 in response to the first found device user input 240. In some embodiments, upon receiving the first found device signal 230, the receiver 150 causes the transmitter 110 to stop emitting the first lost device signal 130 until a user provides a subsequent first lost device user input 120 to the transmitter 110. In some embodiments, the first found device user input 240 is an audible input provided by the user. In some embodiments, the system 10 further comprises a second remote control 300 in electronic communication with the transmitter 110 and configured to emit an audible signal 310 in response to a second lost device signal 135 emitted by the transmitter 110 in response to a second lost device input 120 provided by a user. In some embodiments, the second lost device signal 135 is different than the first lost device signal 130.

1. A system for locating a lost remote control, the system comprising:
a transmitter configured to emit a first lost device signal; and
a first remote control in electronic communication with the transmitter and configured to emit an audible signal in response to the first lost device signal.

2. The system of claim 1, wherein the transmitter is configured to emit the first lost device signal in response to a first lost device user input selection.

3. The system of claim 1, wherein the transmitter is incorporated into electronics of a television device.

4. The system of claim 1, wherein the transmitter is incorporated into an IoT device.

5. The system of claim 4, wherein the IoT device is selected from the group consisting of: a smart speaker (e.g., Amazon Echo, Google Nest, Sonos One, Apple HomePod, JBL Link), a television comprising a virtual assistant, a cable TV modem, a mobile device, a laptop computer, and a desktop computer.

6. The system of claim 5, wherein the IoT device is configured to cause the transmitter to emit the first lost device signal in response to a first audible lost device input provided by a user.

7. The system of claim 1, wherein the transmitter is incorporated into a stand-alone transmitter device comprising:
an activation button in operative communication with the transmitter; and
a power source (e.g., an AC/DC power supply or a DC power supply such as a battery) in operative communication with the transmitter and the activation button,
wherein upon activation of the activation button, the transmitter device emits the first lost device signal.

8. The system of claim 1, wherein the device further comprises a receiver in operative communication with the transmitter and configured to receive a first found device signal from the first remote control,
wherein the first remote control is configured to:
receive a first found device user input upon being located by a user; and
transmit the first found device signal to the receiver in response to the first found device user input.

9. The system of claim 8 wherein, upon receiving the first found device signal, the receiver causes the transmitter to stop emitting the first lost device signal until a user provides a subsequent first lost device user input to the transmitter.

10. The system of claim 8, wherein the first found device user input is an audible input provided by the user.

11. The system of claim 1 further comprising a second remote control in electronic communication with the transmitter and configured to emit an audible signal in response to a second lost device signal emitted by the transmitter in response to a second lost device input provided by a user.

12. The system of claim 11, wherein the second lost device signal is different than the first lost device signal.
